(19) United States
(12) Patent Application Publication
(10) Pub. No.: US 2003/0205696 A1
(43) Pub. Date: Nov. 6, 2003

(54) Carbazole-based materials for guest-host electroluminescent systems

(75) Inventors: Travis P. S. Thoms, San Lorenzo, CA (US); Jian-Ping Chen, San Jose, CA (US)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/131,382

(22) Filed: Apr. 25, 2002

(51) Int. Cl. C09K 11/06; H05B 33/14

(52) U.S. Cl. 252/301.16; 428/690; 428/917; 313/504

(57) ABSTRACT

The invention is directed to guest-host emissive systems suitable for use with organic light emitting devices. In one aspect, the host material comprises a compound having a carbazole core with an electron-donating species bonded to the nitrogen, and aromatic amine groups or carbazole groups bonded to one or more of the carbon atoms. In another aspect, the host material comprises a compound having a single-atom or single-ring core bonded to one or more carbazole moieties, which may themselves be substituted with electron-donating groups. The disclosed host materials have a large band gap potential and high-energy triplet excited states to permit short-wavelength phosphorescent emission by an associated guest material.

### BACKGROUND OF THE INVENTION

1. Field of the Invention

The present invention is directed to guest-host systems which are useful as emissive layers in organic electroluminescent devices (OLEDs). More particularly, the invention is directed to host materials adapted to accommodate fluorescent and phosphorescent guest emitters having shorter emission wavelengths, such as in the blue region of the visible spectrum. In particularly preferred embodiments, the invention is directed to guest-host systems having phosphorescent emissive guests.

2. Description of the Related Art

Organic light emitting devices (OLEDs) typically comprise one or more layers of emissive material between a transparent high-work-function anode, such as indium tin oxide (ITO), and a low-work-function cathode, such as Al, Mg, Ca and their alloys. When a bias is applied across the electrodes, positive charges (holes) and negative charges (electrons) are respectively injected from the anode and the cathode into the emissive layer(s), typically facilitated by hole transport and electron transport layers adjacent the respective electrodes. The holes and the electrons combine in the emissive layer to form excitons which emit light. Depending on the mobility of the charged species, the emissive region may be located closer to the anode or the cathode, and in some cases may be in the hole-transport or electron transport layer. Known multilayer structures are disclosed, for example in B. R. Hsieh, Ed., “Organic Light Emitting Materials and Devices,” Macromolecular Symposia, 125, 1-48 (1997), herein incorporated by reference.

Few organic-based phosphorescent materials can be deposited as neat films. Usually it is necessary to co-deposit them with a host material, either a charge transporting “small” molecule or polymer, to get a reasonable light output.

Well known host materials for guest-host systems include hole-transporting 4,4′-N,N′-dicarbazol-biphenyl (CBP) and electron-transporting aluminum 8-hydroxyquinoline (AlQ₃), which have both been used in OLEDs. However, the known host materials are not suitable host materials for all guests. There continues to be a need in the art for suitable host materials for guests which have short emission wavelengths, such as in the blue region of the spectrum. There is a particular need in the art for host materials which can support guests with phosphorescent emission.

Phosphorescent (as opposed to fluorescent) emission involves a transition from an excited triplet state, usually the first excited triplet state (T1), in which two unpaired electrons have the same spin, to a lower energy state, usually a singlet ground state (S0) in which all electrons are paired. Phosphorescent emission in OLED materials is not unknown, but relatively rare compared to emissions based on singlet (fluorescent) transitions. Likewise, OLEDs based on triplet transitions are relatively undeveloped. Very few phosphorescent guest emitters are known having emission in the blue region of the spectrum, but such emitters will be important in the coming generation of emissive materials. Accordingly, it is highly desirable to develop suitable host materials for guest host systems using these guest emitters.

### SUMMARY OF THE INVENTION

To allow for efficient charge transport through an OLED, and efficient energy transfer between the guest and the host, host materials are preferably selected such that the band gap of the guest material falls within the band gap of the host material. Band gap or band gap potential is defined as the difference in energy between the highest occupied molecular orbital (HOMO) and the lowest unoccupied molecular orbital (LUMO) of a material.

In addition, if the system is a phosphorescent system, the first excited triplet state (T1) of the host materials is preferably higher than the first excited triplet state of the guest. In a fluorescent system, the first excited singlet state of the host is normally higher than the first excited singlet state of the guest. Guest-host systems according to the invention meet the foregoing criteria, even with guest emitters having a relatively short wavelength, such as in the blue region (shorter than 500 nm). As used herein, “phosphorescent system” means an emissive system in which most of the emission intensity is due to transitions from a triplet state, and does not entirely exclude some fluorescent emission. Likewise, a “fluorescent system” means an emissive system in which most of the intensity is due to transitions from a singlet state.

Particularly preferred guest-host systems according to the invention include guest emitters having phosphorescent emission wavelengths in the blue region, and a host with sufficiently high excited triplet state (T1) to permit emission predominantly from the guest, at the characteristic emission wavelength of the guest.

Carbazole derivatives surrounded by electron-donating functionalities have been found to be a good host system for guest emitters with short emission wavelength. These compounds have a sufficiently large band gap, as well as sufficiently high T1 and S1 energy states to allow emission from guests that emit well into the blue spectrum. They also tend to be less inclined to crystallize, offering an additional benefit of a more robust morphology.

Thus, in one aspect, the invention is a guest-host emissive system where the host comprises a carbazole-based compound having the following structure:

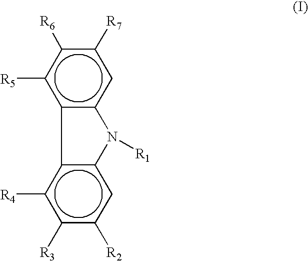

wherein R₁ is an alkyl or aromatic electron-donating moiety, and at least one of R₂ through R₇ is an aromatic amine or carbazole having hole transport capability, and the guest is a light emissive compound having smaller band gap potential than the host. In preferred embodiments the guest-host system is a phosphorescent system, and the guest has a lower first excited triplet state than the host. In the most preferred embodiments, the guest emitter is a phosphorescent emitter with a peak wavelength below about 500 nm.

For example, the carbazole of formula (I) can be advantageously disubstituted with diphenyl amine groups which give the host hole-transport capability, while the electron-donating group at R₁ is a substituted phenyl. Formula (II) below is exemplary:

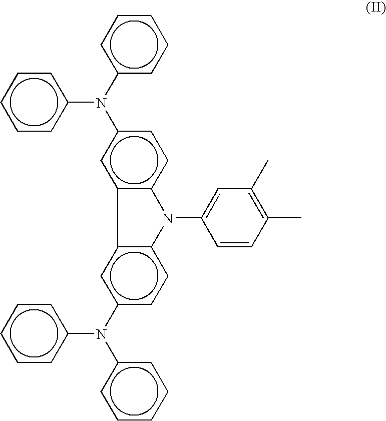

Suitable guest emissive materials can be selected from those known in the art and hereafter developed including, without limitation, tris(2-phenylpyridine)iridium, which has a phosphorescent emission with a peak wavelength of 510 nm, in the green region of the spectrum. In preferred embodiments, the guest has phosphorescent emission in the blue region of the spectrum.

In another aspect, the invention is directed to guest-host systems where the host comprises a small electron-rich core, surrounded by electron-donating functionalities, such as carbazoles. The host compounds having a single ring, or a single carbon atom with electron-donating substituents (such as triphenylmethane), bonded to carbazole groups have a sufficiently large band-gap, and sufficiently high T1 and S1 energy states to allow emission from guest materials that emit well into the blue spectrum.

Thus, one class of guest-host emissive system for use in organic light emitting devices according to the invention comprises a host and a guest, wherein the host comprises a core selected from the group consisting of carbon, benzene, furan, thiophene, pyrrole and tetraphenylmethane, and two or more carbazole groups, or carbazole groups substituted with electron donating functionalities, bonded to the core. The guest is a light emissive material having a smaller band gap potential than the host. If the system is fluorescent, i.e. based predominantly on singlet transitions, then the S1 of the host is higher than S1 of the guest. If the system is phosphorescent, then T1 of the host is higher than T1 of the guest.

An example of a benzene core surrounded by three carbazole branches is shown below as Formula (III)

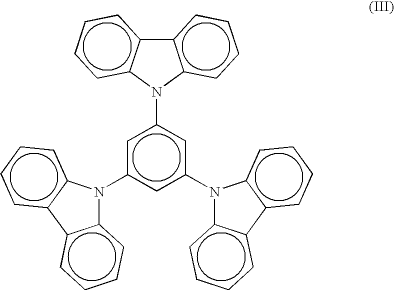

In preferred embodiments, the two or more carbazole moieties may be substituted with electron donating groups, including without limitation, phenyl, alkyl and amine groups. An example of a benzene core having two carbazole moieties substituted with phenyl electron donating groups is shown in Formula (IV):

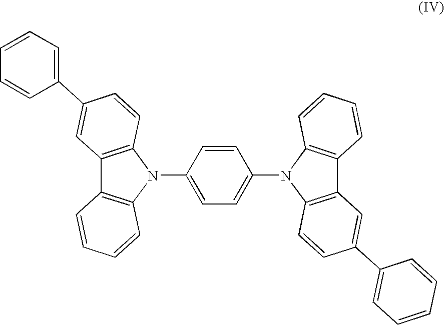

Suitable guest emissive materials can be selected from those known in the art and hereafter developed, including those discussed below.

This brief summary has been provided so that the nature of the invention may be understood quickly. A more complete understanding of the invention can be obtained by reference to the following detailed description of the preferred embodiments thereof in connection with the attached drawings.

### DETAILED DESCRIPTION OF THE INVENTION

As understood herein, a guest host system is one in which a guest emitter compound is doped into a host compound matrix. Overall, it is desired to obtain an emission from the guest-host system such that the emission spectrum of the system is close to the emission spectrum of the guest, the ultimate goal being a narrow bandwidth, high intensity emission at the appropriate blue, green or red region of the visible spectrum.

So that the emission of the host does not interfere with the emission of the guest, and so that non-light-producing transitions in the system are minimized, efficient energy transfer from the host to the guest is preferred. As a first technique to promote efficient energy transfer, the band gap of the guest should fall within the band gap of the host.

A second technique to promote efficient energy transfer between host and guest relates to orbital alignment. In a singlet host/singlet guest system, efficient energy transfer occurs when there is overlap between the emission spectra of the host and the absorption spectra of the guest. However, where the host has a singlet-based emission spectra, and the guest has a triplet-based emission spectra, this approximation does not hold. If the excited triplet state of the guest is higher than that of the host, exciplex formation can occur and good energy transfer will not occur. In these circumstances, it is ordinarily preferable to select a host having a higher T1 state than the T1 state of the guest to ensure efficient energy transfer. This becomes more difficult to achieve as the wavelength of emission for the guest becomes shorter; however, the inventors herein have found that this is achievable by providing a carbazole based host material with suitable electron donating groups. Thus, one aspect of the invention lies in identifying suitable host materials by their T1 energy levels (actual or computed), relative to the T1 energy levels of a guest emitter.

Band gap and T1 and S1 states can be obtained experimentally or estimated computationally based on chemical structure. The computational method may be advantageously used to select candidate hosts. Where computed values are recited herein, the computational work was done on an IBM PC™ platform using Windows 2000™. Structures were drawn and preliminary geometry optimization (using the MM2 engine, a publicly available algorithm) was performed using Hyperchem 6.0™ molecular modeling software available from Hypercube, Inc., Gainesville, Fla. The structure files were converted and a final geometry optimization was completed using the MOPAC 6.0 program interface available within Hyperchem™, and the AMI semi-empirical methods (a publicly available algorithm). Structures were then converted back to Hyperchem™ format and single point CI determinations were made via the ZINDO/S methods to determine theoretical HOMO, T1 and S1 excited-state energy levels. Other suitable numerical methods for computing these values may be known in the art, or may be hereafter developed.

Calculated T1 values are used to compare candidates for host materials. It is believed that the same method used to evaluate two materials computationally will give reasonably accurate information about their relative T1 states, and therefore about their relative suitability as host materials. However, the computational methods will not accurately predict actual T1 energy levels of a candidate host material. It is also believed that in order to analyze candidate host materials using a computational method, the compounds must be structurally similar to make valid comparisons.

To have high quantum efficiency, i.e. a high percentage of injected charges resulting in the production of photons of visible light, host materials allow for charge transport (holes or electrons) through the device. The guest-host systems described and claimed herein all have host materials characterized by hole transport capability, which is afforded by the arylamine or carbazole branches thereof.

In a first embodiment, the host material of the guest-host system comprises a carbazole core, having hole-transporting carbazole or arylamine moieties bonded thereto. At the nitrogen atom of the carbazole core, electron donating species are attached to provide the host material with a higher energy excited S1 or T1 state. Thus, in formula (I) below, appropriate electron-donating groups for R1 may be selected from substituted or unsubstituted alkyl electron-donating groups and substituted, unsubstituted, or hetero-substituted aromatic electron-donating groups. Suitable electron-donating groups include, without limitation, C₁-C₈ branched or straight chain alkyl, phenyl,

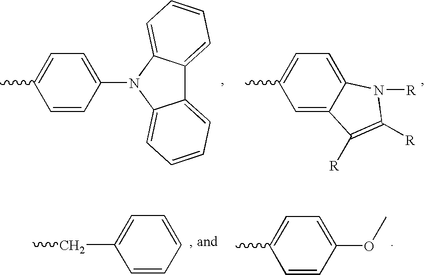

R₂ through R₇ are hole-transporting carbazole or arylamine groups, which may advantageously themselves be substituted with electron-donating groups.

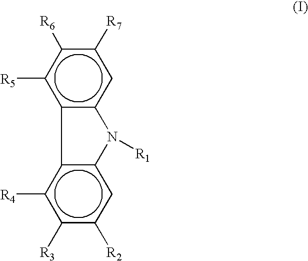

Methods of making compounds according to formula (I) may be found in the prior art. For example, a method of making 3,6-Di(diphenylamino)-9-alkylcarbazoles is disclosed in S. Grivalevicus, et al., “3,6-Di(diphenylamino)-9-alkylcarbazoles: novel hole transporting molecular glasses.” Synthetic Metals, 122 (2001) 311-314, incorporated herein by reference. Substitution of the alkyl group disclosed therein with other electron-donating groups at R₁ is possible. The suitability of these materials as host materials in guest-host luminescent systems has not been explored heretofore, and the criteria for selecting appropriate carbazole-containing materials for these applications have not been systematically exploited. The most preferred hole-transporting groups are di-phenylamine groups, as in the following preferred embodiment:

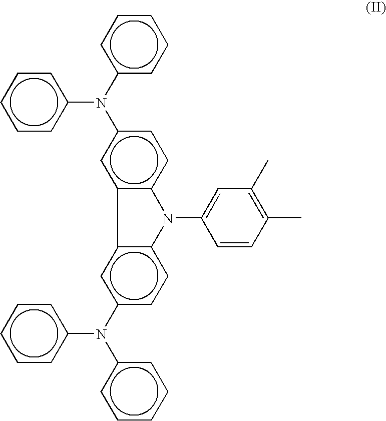

A compound according to this embodiment of the invention with methyl as the electron donating group R, was made according to Scheme 1.

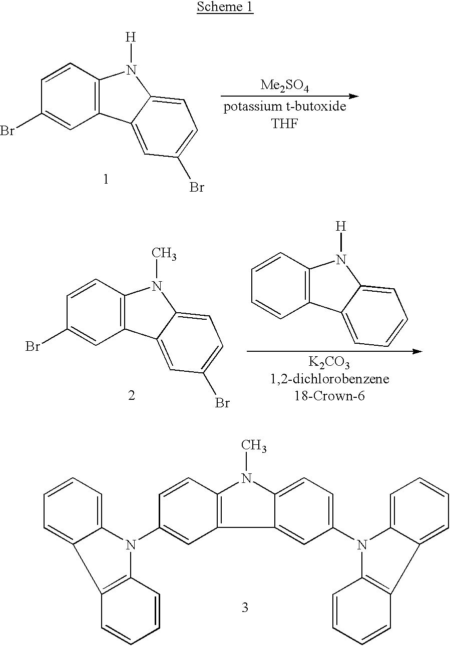

2.5g 3,6-dibromocarbazole was placed in a dry, nitrogen-filled flask and flushed two times with nitrogen. 25 mL of anhydrous tetrahydrofuran (THF) was added, as well as 10 mL of 1.0 M potassium butoxide solution in THF, with 1 mL of dimethylsulfate. The mixture was refluxed overnight. The mixture was then poured with stirring into methanol and the product (2) was removed as a solid.

1.226 g of compound 2 was then placed in a dry, nitrogen-filled flask with 1.417 g carbazole, 0.7413 g copper powder, 2.21g potassium carbonate, and 0.204 g 18-crown-6 ether, and was flushed two times with nitrogen. 35 mL of 1,2-dichlorobenzene was added and the mixture refluxed over two days. After reflux, the solids were filtered out, washed with methylene chloride, and discarded. The reaction solution and methylene chloride were combined and the mixture volume was reduced under rotary vacuum. The resulting reduced volume solution was allowed to sit and crystal formation occurred. Solution and solids were separated, and the solution was eluted through a basic alumina column first with a 1:4 ethyl acetate/hexane solution, followed by methylene chloride as the eluent. Emissive purple fractions were combined. Crystals were dissolved in methylene chloride and eluted through a basic alumina column with methylene chloride. An emissive purple fraction was collected. Fractions were condensed under rotary vacuum, and precipitated in ethyl acetate, leaving compound 3.

In a second embodiment, the guest host system according to the invention comprises a host compound having a small electron-rich core with carbazole groups attached thereto. Suitable core materials include benzene, furan, thiophene, pyrrole and tetraphenylmethane.

An example of a host compound having a small core with carbazoles bonded thereto is tricarbazole benzene (TCB)

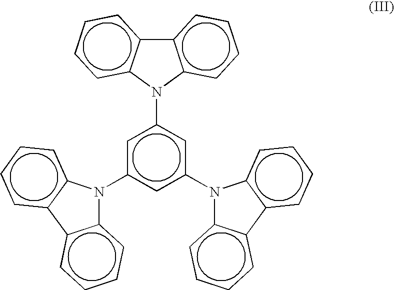

This compound was synthesized as follows:

1.0179 g of 1,3,5 tribromobenzene, 2,763g K₂CO₃, 1.734 g carbazole, and 0.6255 g Cu powder were combined in a dry, nitrogen filled flask, and flushed three times with nitrogen. 40 mL of nitrobenzene were added and mixture was set to reflux for three days. After reflux, the hot solution was vacuum filtered through a paper filter, and then added to 120 ml of methanol. The product in the form of a precipitate was removed by filtration.

The product was then redissolved in chloroform, and eluted through a neutral alumina column using an 8:2 methylene chloride/hexane solution as the eluent. The fraction was brought to dryness and recrystallized in a 1:4 chloroform/hexane solution.

In especially preferred embodiments, the carbazole groups may be substituted with electron donating groups An example is 1,4,-bis-3-phenylcarbazole benzene having the following structure:

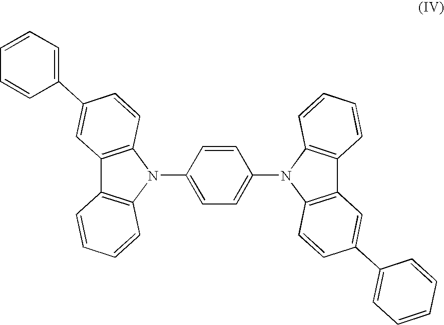

Without wishing to be bound by theory it is believed that the electron-donating groups attached to the carbazole groups enhance the ability of the carbazole groups to be more electron-donating, which in turn raises the T1 state of the material as a whole. In some instances, a group attached to one or more of the carbazole groups may be nominally electron-donating, but the group has such a degree of conjugation that its overall effect is to reduce the electron-donating ability of the carbazole. Accordingly, groups such as the fused benzene rings on compounds (IX) and (X) below are less preferred substituents on the carbazole groups.

To synthesize the above compound (IV), an intermediate, 3-phenyl-1,2,4-trihydro-carbazole was made as follows: to a flask were added phenylhydrazine (2.16 g, 2 mmol), 4-phenylcyclohexanone (3.48 g, 2 mmol), 1 mL of HCl and 20 mL of acetic acid. The mixture was refluxed under N₂ overnight. After cooling, the product was filtrated, washed with water, and recrystallized from methanol. The yield obtained was 2.8 g (56%). The compound exhibited a melting temperature (Tm) as determined by differential scanning calorimetry (DSC) of 131° C.

The intermediate product was then dehydrogenated with 5% palladium charcoal at 250° C. for 30 min to afford 3-phenyl-carbazole, having an IR(neat) peak of 3410 cm⁻¹ (NH); and a melting temperature determined by DSC of Tm=221° C.

Then, the 3-phenylcarbazole (0.729 g, 3 mmol), 1,4-diiodobenzene (0.495 g, 1.5 mmol), copper powder (0.19 g, 3 mmol), K₂CO₃ (0.828 g, 6 mmol), and 18-Crown-6 ether (60 mg, 0.23 mmol) were placed in a dry round-bottom flask connected with a condenser. The system was evacuated and purged with N₂ for at least 2 cycles. Under N₂, 1,2-dichlorobenzene (6 mL, b.p. 180° C.) was added, and the mixture was refluxed for 2 days. The hot solution was filtrated through a bed of silica to remove solids. The filtrate was drop-added into methanol and the precipitate was filtered and washed with methanol. The product 1,4,-bis-3-phenylcarbazole-benzene was purified by recrystallization from toluene. The observed yield was 0.50 g (60%); Tm=277° C.

Another example is 3-phenyl tricarbazole benzene (3-ph TCB):

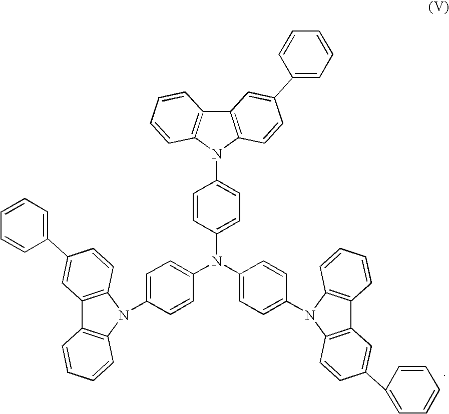

Suitable guest emitter materials include fluorescent and phosphorescent emitters, either presently known or hereafter developed, having any visible emission wavelength. For display applications, emitters having a peak in the red, green or blue portion of the visible spectrum are particularly preferred. Using computational methods described herein it is possible to select candidate host materials prior to synthesizing the materials themselves. It must be recognized, however, that computation methods give reliable information only concerning trends in T1 energy levels among similar materials, and not actual T1 levels for specific compounds.

Several suitable fluorescent red, green, blue, white and yellow dopants are described in B. R. Hsieh, Ed., “Organic Light Emitting Materials and Devices,” Macromolecular Symposia, 125, 1-48 (1997), herein incorporated by reference.

Phosphorescent dopants are relatively rare. Irppy3, which has a green phosphorescent emission, is used in the Examples. A series of blue phosphorescent emitters is disclosed in WO 01/39234, having the following structure:

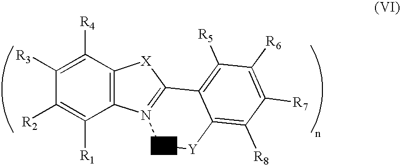

wherein M represents a metal (such as zinc); X and Y are independently O or S; n is an integer from 1 to 3; and R₁ to R₈ are independently hydrogen, aryl or alkyl. WO 01/39234 is incorporated herein by reference.

The suitability of host materials according to the invention may be demonstrated by comparison to the standard host, CBP, which has the following structure:

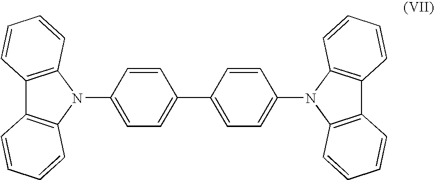

CBP is not usually a suitable host for guest emitters having a wavelength approaching about 475 nm and below, as CBP has an emission peak at this wavelength. The inventors herein have discovered that providing electron donating groups to the carbazole moiety, or using a small electron-rich core with carbazole moieties bonded thereto raises the first singlet or triplet excited state of the host relative to the guest, so as to accommodate shorter wavelength emitting guests.

For example, the compound 1,4-Bis(carbazolyl)benzene (CCP) has the following structure:

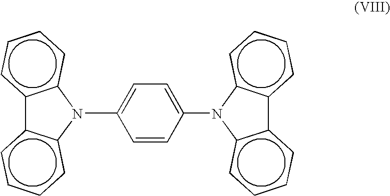

similar to CBP, except that the core is benzene and not biphenyl. The excited triplet state of CCP is higher than that of CBP. The use of CCP as a host in a guest-host system with a guest having a lower first excited singlet or triplet state is within the scope of the invention.

TABLE 1

| | T1 max | T1 peak |
|---|---|---|
| CBP | 2.81 | 2.67 |
| CCP | 3.08 | 3.02 |

The syntheses of CBP and CCP are set forth in B. E. Koene, et al. “Asymmetric Triaryldiamines as Thermally Stable Hole Transporting Layers for Organic Light Emitting Devices,” Chem. Mater. Vol. 10, No. 8, 2235-2250 (1998), incorporated herein by reference.

As a comparative example, a CBP analog 1,4,-Bis-dibenzocarbazolyl biphenyl (db-CBP) with the following structure was prepared using an Ullman coupling reaction.

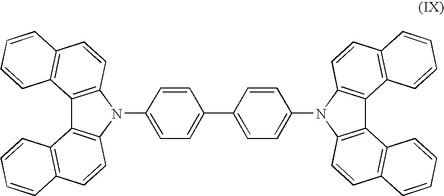

The use of this compound as a host in a guest host system would be outside the scope of the invention because of the biphenyl core. Also, the fused benzene rings on the carbazole groups render the carbazole groups less electron donating, lowering T1.

As a further comparative example 1,4-Bis-(dibenzocarbazolyl)benzene (db-CCP) was prepared having the following structure:

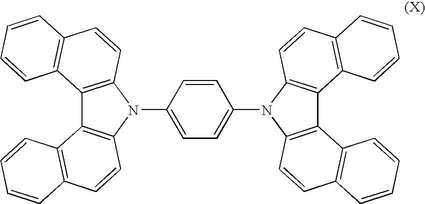

The fused benzene rings on the carbazole moieties reduce the electron-donating characteristic of the carbazole and therefore the use of this compound as a host material in a guest-host system would be less preferred. While such material may not be a good host for an emitter having a characteristic emission wavelength shorter than 500 nm (in the blue region), it may make a suitable host for a red or green guest emitter.

The foregoing compounds including TCB and 3-ph TCB, were tested in an OLED with an Irppy3 guest emitter dopant. All organic layers were deposited by thermal evaporation via an UTLVAC thermal deposition chamber onto indium tin oxide (ITO) at 10⁻⁴ Pa. A layer of N′N′-bis-(1-naphthyl)-N,N′-1-diphenyl-1,1′-biphenyl-4,4′-diamine (α-NPB) purchased from Dojindo Laboratories, Japan was deposited to 40 nm, followed by deposition of the 40 nm thick emitting layer consisting of Irppy₃ doped into the host material (5% wt/wt), an exciton-blocking layer of 10 nm thick Bathocuproine (BCP), and an electron-transporting layer of 400 nm thick AiQ₃ lrppy₃, AiQ₃ and BCP were obtained from Dojindo Laboratories, Japan. A 10 nm layer of aluminum-lithium alloy (AlLi) (Li 1.8wt %) covered by 150 nm of aluminum was deposited as a cathode.

Measurements of the photoemission of the above OLEDs were made using photoluminescence on a Hitachi F-4500 spectrofluorometer. The results are tabulated in Table 2 below, including luminescent efficiency, observed T1 (max), observed T1 (peak) and calculated HOMO for each compound. Calculated T1 values showing trends are also provided.

TABLE 2

| | HOMO | T1 | T1 | T1 | |
|---|---|---|---|---|---|
| Host | (calc.) | (calc.) | (max) | (peak) | Lumens/W |
| CBP | −7.22 | 0.01 | 2.81 | 2.67 | 6.2 |
| db-CBP | −6.95 | −0.39 | 2.45 | 2.38 | ’10.3 |
| CCP | −7.25 | −0.06 | 3.08 | 3.02 | 0.7 |
| db-CCP | −6.95 | −0.39 | 2.42 | 2.37 | 0.01 |
| TCB | −7.60 | 0.11 | 3.07 | 2.82 | 1.8 |
| 3-ph TCB | −6.93 | 0.10 | 2.92 | 2.82 | 12.2 |

Thus host materials better than CBP for short wavelength emitting guests are made by providing carbazole groups with electron rich cores, which can be further advantageously modified by attaching electron donating groups to the carbazole groups.

Host material compounds having a small, electron rich-core with carbazole groups attached thereto may be represented by the following formulae:

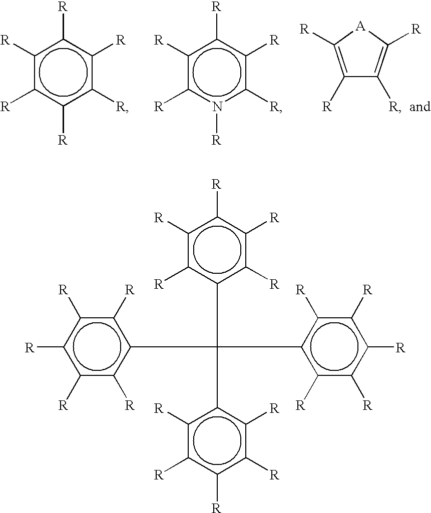

wherein A is O, S or N, and at least two R are carbazole or substituted carbazole. A suitable guest may be a phosphorescent emitter having a wavelength shorter than about 500 nm, having a lower first excited triplet state higher than the host compound.

The foregoing specific examples are illustrative only and are not to be considered as limiting the invention, which is defined by the following claims.

We claim:

1. A guest-host emissive system for use in an organic light emitting device comprising a guest and a host, wherein the host comprises a carbazole-based compound having the following structure: 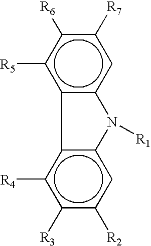
wherein R₁ is an electron-donating group,
and at least one of R₂ through R₇ is an aromatic amine or carbazole moiety having hole transport capability, and
wherein the guest is a light emissive compound having smaller band gap than the host.

2. The guest-host emissive system of claim 1, wherein the guest is a phosphorescent emitter and has a lower first excited triplet state than the host.

3. The guest host emissive system of claim 1, wherein emission by the guest is at a wavelength less than about 500 nm.

4. The guest-host emissive system of claim 1, wherein the guest is a fluorescent emitter and has a lower first excited singlet state than the host.

5. The guest-host emissive system of claim 1, wherein emission by the guest host system is substantially at the characteristic emission wavelength of the guest.

6. The guest-host emissive system of claim 1, wherein R₁ is selected from the group consisting of substituted and unsubstituted alkyl electron-donating groups, and substituted, unsubstituted and hetero-substituted aromatic electron-donating groups.

7. The guest-host emissive system of claim 1, wherein R₁ is selected from the group consisting of alkyl groups and aromatic groups.

8. The guest-host emissive system of claim 1, wherein R₁ is selected from the group consisting of C₁-C₈ branched or straight chain alkyl, phenyl,

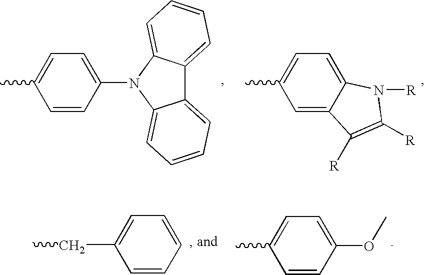

9. The guest-host emissive system according to claim 1, wherein the carbazole-based compound has the following structure:

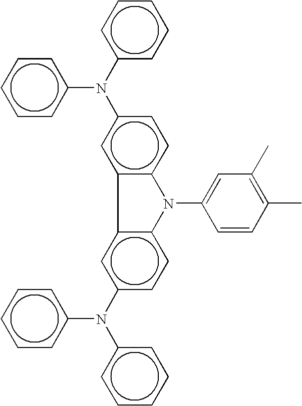

10. A guest-host emissive system for use in an organic light emitting device comprising a host and a guest,
wherein the host comprises a core selected from the group consisting of carbon, benzene, furan, thiophene, pyrrole and tetraphenylmethane, and two or more carbazole groups or carbazole groups substituted with electron-donating groups bonded to said core, and
wherein the guest is a light emissive material having a smaller band gap potential than the host.

11. The guest-host emissive system of claim 10, wherein at least one of said carbazole groups is substituted with at least one electron-donating group selected from the group consisting of phenyl electron-donating groups, alkyl electron-donating groups, and amine electron-donating groups.

12. The guest-host emissive system of claim 10, wherein said guest is a phosphorescent emitter and has a lower first excited triplet state than the host.

13. The guest-host emissive system of claim 10, wherein said guest is a fluorescent emitter and the guest has a lower first excited singlet state than the host.

14. A guest-host emissive system according to claim 10, wherein emission by the guest is at a wavelength shorter than 500 nm.

15. A guest-host emissive system according to claim 10, wherein the host comprises a compound selected from the group consisting of a

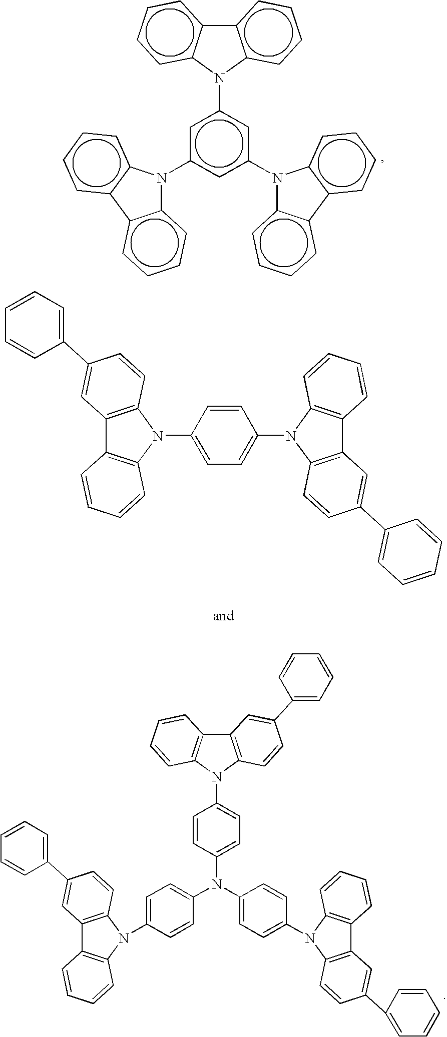

16. A guest-host emissive system for use in an organic light emitting device comprising a host and a guest,
wherein the host comprises a compound selected from the group consisting of 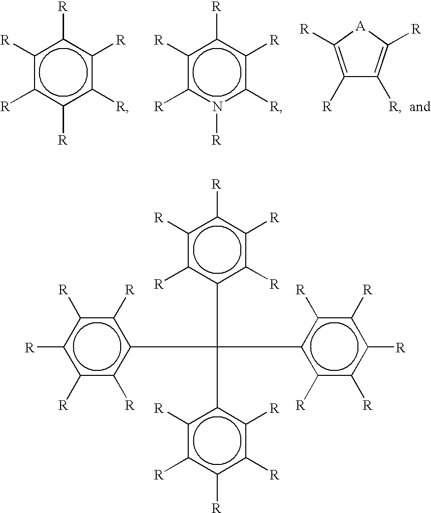
wherein A is O, S or N, and at least two R are carbazole or substituted carbazole, said guest is a phosphorescent emitter having a wavelength shorter than about 500 nm, and said host has a first excited triplet state higher than said guest.
